(19) United States
(12) Patent Application Publication
(10) Pub. No.: US 2026/0162341 A1
(43) Pub. Date: Jun. 11, 2026

(54) TRAINING AN IMAGE GENERATION SYSTEM TO EDIT INPUT IMAGES TO REFLECT CAMERA FIELD OF VIEW CHANGES

(71) Applicant: Google LLC, Mountain View, CA (US)

(72) Inventor: Amelio Vázquez-Reina, Palo Alto, CA (US)

(21) Appl. No.: 19/417,300

(22) Filed: Dec. 11, 2025

Related U.S. Application Data
(60) Provisional application No. 63/730,963, filed on Dec. 11, 2024.

(51) Int. Cl. G06T 13/20; G06T 7/20; G06T 7/70; G06T 15/20

(52) U.S. Cl. CPC G06T 13/20; G06T 7/20; G06T 7/70; G06T 15/20; G06T 2207/10016; G06T 2207/20081; G06T 2207/20084; G06T 2207/30241; G06T 2207/30244

(57) ABSTRACT

Methods, systems, and apparatus, including computer programs encoded on computer storage media, for training an image generation system to edit images. For example, the image generation system can be trained to edit input images to reflect camera field of view changes.

### CROSS-REFERENCE TO RELATED APPLICATION

This application claims priority to U.S. Provisional Application No. 63/730,963, filed on Dec. 11, 2024. The disclosure of the prior application is considered part of and is incorporated by reference in the disclosure of this application.

### BACKGROUND

This specification relates to generating images using machine learning models.

As one example, neural networks are machine learning models that employ one or more layers of nonlinear units to predict an output for a received input. Some neural networks include one or more hidden layers in addition to an output layer. The output of each hidden layer is used as input to another layer in the network, e.g., the next hidden layer or the output layer. Each layer of the network generates an output from a received input in accordance with current values of a respective set of weights.

### SUMMARY

This specification describes a method, implemented as a computer program on one or more computers in one or more locations, for training an image generation system to edit input images. That is, the system trains an image generation system to generate output images that are edited versions of input images that are received by the image generation system.

In particular, the system trains the image generation system to perform edits that specify three-dimensional scene updates, i.e., based on prompt inputs that specify changes to the field of view of the camera that corresponds to the image.

Examples of such edits include edits that specify movements of the camera that captured a given image within the scene and edits that specify a change to the zoom level of the camera that captured the given image.

Particular embodiments of the subject matter described in this specification can be implemented so as to realize one or more of the following advantages.

Image generation neural networks, i.e., neural networks that generate images, have a wide variety of uses. For example, denoising neural networks that generate images, e.g., conditioned on text prompts on or other conditioning inputs, have gained prominence across a variety of fields due to their ability to generate visually compelling outputs that accurately reflect the context provided by a given conditioning input.

However, existing image generation systems struggle to generate images that accurately reflect changes to the underlying three-dimensional (3D) scene depicted in the input image. For example, some existing image generation systems can accurately edit input images in response to edits that maintain a static camera view, but generate degraded, implausible, or inconsistent images when the edit requires changing the camera view, i.e., changing which region of the 3D scene is visible in the input image.

The techniques described in this specification address these issues by training the image generation system to effectively incorporate edits that require depicting the underlying the scene from a different camera view. In particular, by effectively generating a large number of training examples that demonstrate these types of edits and then incorporating these training examples into the training of the image generation system, the described techniques yield an image generation system that can effectively edit images in response to many different types of prompts that request to change the camera view.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a diagram of an example training system.

FIG. 2 shows an example of a training example.

FIG. 3 shows another example of a training example.

FIG. 4 is a flow diagram of an example process for generating training examples for training an image generation system.

FIG. 5 is a flow diagram of an example process for generating a training example from a given spatial trajectory.

FIG. 6 is a flow diagram of an example process for generating a natural language instruction.

Like reference numbers and designations in the various drawings indicate like elements.

### DETAILED DESCRIPTION

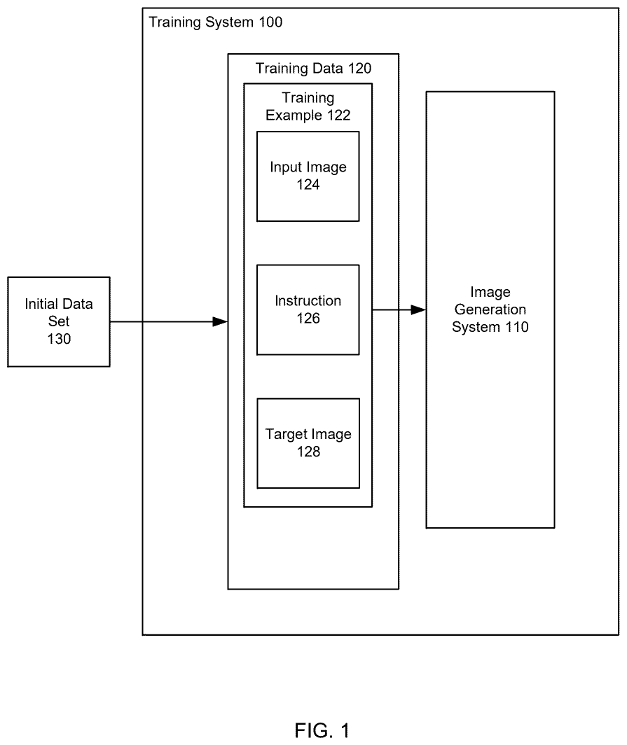

FIG. 1 is a diagram of an example training system 100. The training system 100 is an example of a system implemented as computer programs on one or more computers in one or more locations, in which the systems, components, and techniques described below can be implemented.

The system 100 generates training data 120 for training an image generation system 110. Once the system 100 has generated the training data 120, the system 100 or another training system can train the image generation system 110 on the training data 120.

The image generation system 110 can be any appropriate neural network system that generates output images in response to inputs that include (i) an input image and (ii) a text prompt. That is, the image generation system 110 can be any appropriate system that generates output images conditioned on an input image and a text prompt, i.e., a natural language text instruction that represents an edit to be made to the input image.

For example, the image generation system 110 can be a text-conditional denoising model, e.g., a diffusion model, a rectified flow model, a multi-step consistency model, and so on. One example of such a neural network is described in MobileDiffusion: Instant Text-to-Image Generation on Mobile Devices, available at arXiv:2311.16567. Another example of such a neural network is described in Flow Straight and Fast: Learning to Generate and Transfer Data with Rectified Flow, available at arXiv:2209.03003. Another example of such a neural network is described in Multistep Consistency Models, available at arXiv:2403.06807.

As another example, the image generation system 110 can be an auto-regressive model that auto-regressively generates tokens representing the output image conditioned on tokens representing the input image and the text prompt. For example, the image generation system 110 can be a multi-modal large language model (LLM) or a different auto-regressive image generation model.

The training data 120 includes a set of training examples 122. Each training example 122 includes (i) an input image 124, (ii) a natural language instruction 126, and (iii) a target image 128.

The target image 128 represents, i.e., appears to be, an image that is generated by applying an edit specified by the natural language instruction 126 to the input image 124.

Generally, the natural language instruction 126 specifies an edit that specifies a change in the field of view of the camera corresponding to the input image 124.

When the source image 124 is a real-world image, the camera corresponding to the source image 124 can be the camera that captured the source image 124.

When the source image 124 is a synthetic image, the camera corresponding to the source image 124 can be a virtual camera, i.e., so that the camera pose is the camera pose from which the source image 124 was generated.

For example, the instruction 126 can define a change to be applied to the camera pose of the camera corresponding to the source image 124. In other words, the natural language instruction 126 specifies how to move the camera in order to generate the target image 128.

As another example, the instruction 126 can specify a change to the zoom level of the camera corresponding to the source image 124. As a particular example, the instruction can request to zoom out on the source image 124, thereby increasing the field of view relative to the source image 124.

As yet another example, the instruction 126 can specify both a change to the zoom level and a change in camera pose.

In some implementations, for some or all of the training examples 122, the natural language instruction 126 also specifies changes in visual appearance caused by the change in the field of view. That is, the natural language instruction 126 specifies visual differences between the source 124 and target images 128 caused by the change in camera pose, by increasing the field of view, or both. For example, the natural language instruction can describe objects or other aspects of the scene that should be depicted in the portion of the scene that was not within the field of view of the camera in the source image 124 but that is within the field of view of the camera in the target image 128.

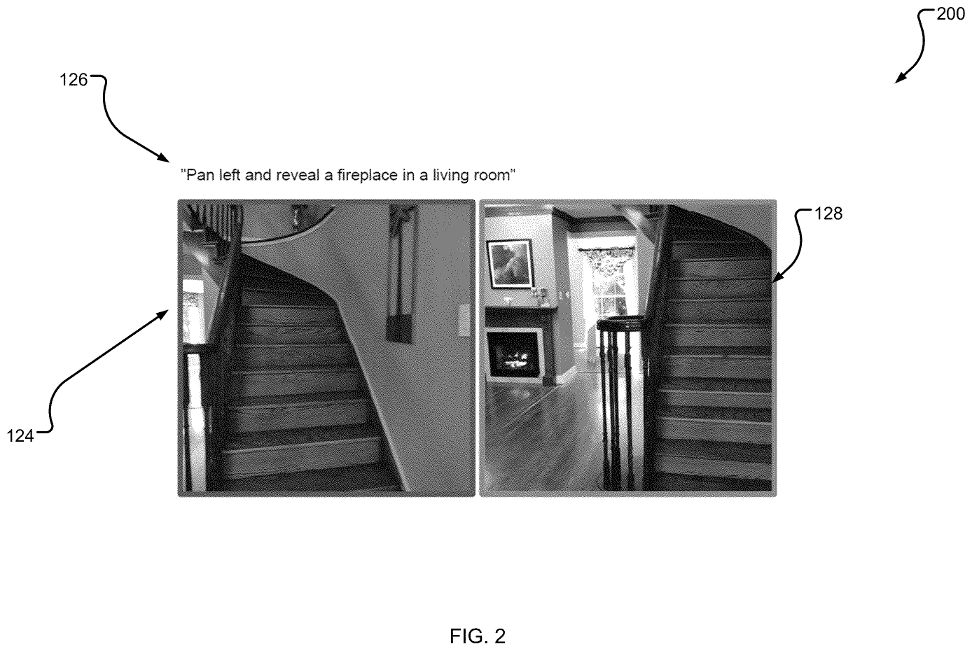

FIG. 2 shows an example 200 of a training example 122.

As shown in the example 200, the training example 122 includes (i) an input image 124, (ii) a natural language instruction 126, and (iii) a target image 128. In the example of FIG. 2, the input image 124 is a real-world image captured by a camera and the instruction 126 (“Pan left and reveal a fire place in a living room”) specifies an edit to change the camera pose (“pan left”) and a change in visual appearance caused by the change to the camera pose (“reveal a fire place in a living room”).

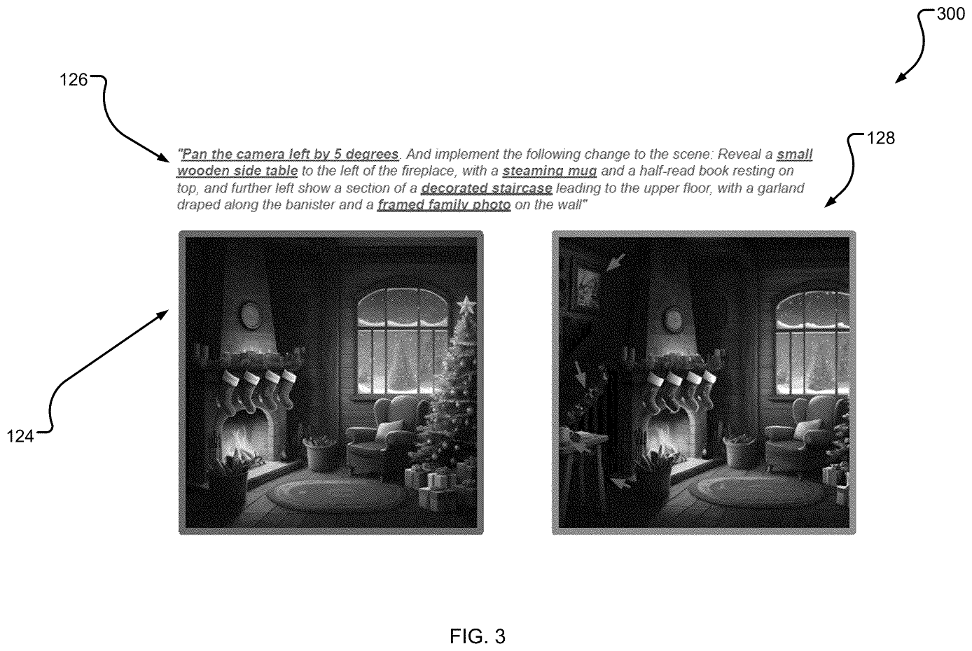

FIG. 3 shows another example 300 of a training example 122.

As shown in the example 300, the training example 122 includes (i) an input image 124, (ii) a natural language instruction 126, and (iii) a target image 128. In the example of FIG. 2, the input image 124 is a synthetic image and the instruction 126 (“Pan the camera left by 5 degrees . . . ”) specifies an edit to change the camera pose (“pan the camera left by 5 degrees”) and a change in visual appearance caused by the change to the camera pose (“and implement the following change to the scene . . . ”).

As can be seen from the examples 200 and 300, the instructions 126 in different training examples 122 can reflect different levels of detail and different types of changes to the scene.

Returning to the description of FIG. 1, the system 100 generates the training data 120 from an initial data set 130. For example, this data set 130 can include one or more of i) videos, ii) 3d representations of scenes (“3D assets”), or iii) collections of images of a three-dimensional environment, e.g., interactive panoramas of the real-world environment.

That is, in some implementations, the data set 130 includes a set of videos that each depict a respective scene over time. More specifically, the set of videos can include videos with dynamic camera motion, i.e., videos where the camera pose changes between different video frames in the video.

The system 100 can also obtain, for each video frame of each video, a respective camera pose for the camera corresponding to the video frame. In some implementations, the system receives the camera pose data for the video frames as input. In some other implementations, the system generates the camera pose data by applying a pose estimation technique to the input videos. For example, the system can employ a structure from motion (SfM) technique to estimate the camera pose for each of the video frames.

In some implementations, the data set 130 includes 3D assets, where each 3D asset defines a 3D representation of a corresponding 3D scene. A 3D asset can be any appropriate data that can be used by a rendering engine to render synthetic images of the corresponding 3D scene from arbitrary viewpoints. Examples of 3D assets include data defining, i.e., the parameters of, neural radiance fields (NeRF) models or 3D gaussian splatting (3DGS) models, 3D models of objects, 3D mesh representations of scenes, and so on.

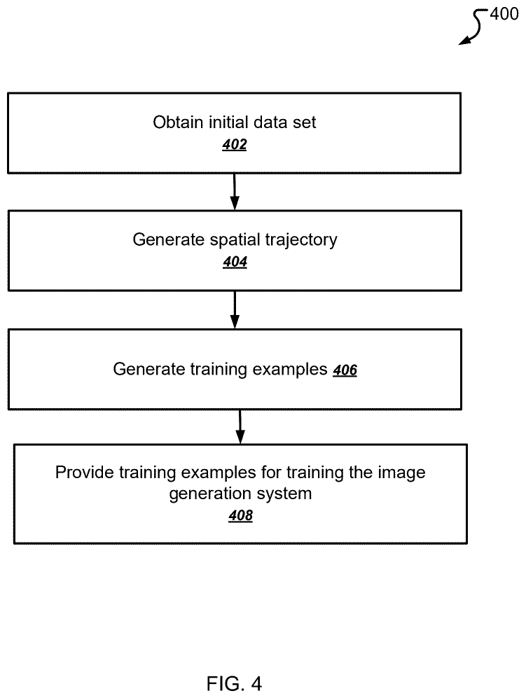

The system 100 then generates the training examples 122 using images extracted from the initial data set 130. Generating training examples is described in more detail below with reference to FIGS. 4-6.

As described above, once the system 100 has generated the training data 120, the system 100 or another training system can train the image generation system 110 on the training data 120.

The system can train the image generation system 110 on a training objective that is appropriate for the type of neural network system being trained. For example, when the image generation system 110 is a diffusion model, the system can train the image generation system 110 on a diffusion score matching objective or another appropriate diffusion model training objective. As another example, when the image generation system 110 is a rectified flow model, the system can train the image generation system 110 on a flow matching objective or another appropriate training objective. As yet another example, when the image generation system 110 is a multi-step consistency model, the system can train the image generation system 110 on a multi-step consistency training loss. As another example, when the image generation system 110 is an auto-regressive image generation model, the system can train the image generation system 110 on a next token prediction objective.

After the training, the system 100 or another inference system can use the trained image generation system 100 to generate new images. For example, the system 100 can receive a new image and a new instruction that specifies a new edit to the new image and then process the new image and the new instruction using the image generation system to generate a new output image in which the new edit has been applied to the new image.

FIG. 4 is a flow diagram of an example process 400 for generating training data. For convenience, the process 400 will be described as being performed by a system of one or more computers located in one or more locations. For example, a training system, e.g., the training system 100 depicted in FIG. 1, appropriately programmed in accordance with this specification, can perform the process 400.

The system obtains an initial data set (step 402). For example, as described above, the initial data set can include (i) videos, (ii) 3D assets, or (iii) both.

The system generates, from the initial data set, a plurality of spatial trajectories of images (step 404). Each trajectory includes a respective set of images of a corresponding scene. The trajectories are referred to as “spatial” trajectories because different images within the same trajectory depict different spatial regions of the corresponding scene.

For example, when the initial data set includes a set of videos, the system can generate one or more spatial trajectories from each video.

To generate a given spatial trajectory from a video, the system can sample a subset, e.g., a proper subset, of the frames in the video. As a particular example, the system can select an offset that defines the time index in the video of the first image in the trajectory and a stride value that defines the difference in time indices between adjacent frames in the video and then sample frames from the video in accordance with the offset and the stride value.

In some cases, the system can generate multiple different spatial trajectories from the same video by making use of different combinations of offset and stride values.

As another example, when the initial data set includes a set of 3D assets, the system can generate one or more spatial trajectories from each 3D asset.

For example, the system can generate a respective spatial trajectory from a given 3D asset by, for each of a plurality of camera poses, rendering, using the 3D asset, a respective image of the corresponding 3D scene taken from the camera pose. The system can perform this rendering in any appropriate way, depending on the type of the 3D asset. For example, when the asset is data defining, i.e., the parameters of a learned model of the 3D scene, e.g., neural radiance fields (NeRF) models or 3D gaussian splatting (3DGS) models, the system can render an image by providing a camera pose as input to the learned model and processing the input using the learned model to generate a rendered image of the scene from the camera pose. As another example, when the 3D asset includes one or more 3D models of objects or 3D mesh representations of scenes, the system can provide the 3D asset and the camera pose as input to a 3D rendering engine and obtain, as output from the rendering engine, the rendered image of the scene from the camera pose.

As a particular example, the plurality of camera pose can be points on an N-degree of freedom grid of camera pose locations within the corresponding 3D scene, where N is a positive integer. That is, each point in the grid can correspond to a different N-degree of freedom camera pose location. For example, if camera pose is represented as a 6 degree of freedom camera pose, N can be equal to 6. For example, the 6 degrees of freedom can correspond to coordinates in a 3D coordinate system, pitch, yaw, and roll.

In some cases, a given trajectory includes a respective image from each of the points in the grid while in other cases different trajectories generated from the same 3D asset can include images from different subsets of the points in the grid.

The system generates, using the spatial trajectories of images, a plurality of training examples (step 406). Each training example includes (i) an input image, (ii) a natural language instruction, and (iii) a target image generated by applying an edit specified by the natural language instruction to the input image. As described above, the natural language instruction specifies a change in the field of view of the camera corresponding to the input image.

For example, the system can generate a respective training example for each adjacent pair of images in each spatial trajectory. As another example, the system can sample, e.g., randomly or in accordance with another distribution over the images in the trajectory, pairs of images from each spatial trajectory and then generate a respective training example for each sampled pair of images.

The system provides the plurality of training examples for training the image generation system (step 408). For example, the system can provide the training examples to another training system. As another example, the system can train the image generation system.

Generally, the system can train the image generation system on any appropriate objective that measures a degree to which the image generation system can accurately generate, for each training example, the target image in the training example conditioned on the input image and the natural language instruction in the training example. Examples of such objectives include score matching objectives for diffusion models, next token prediction objectives for auto-regressive neural networks, and so on.

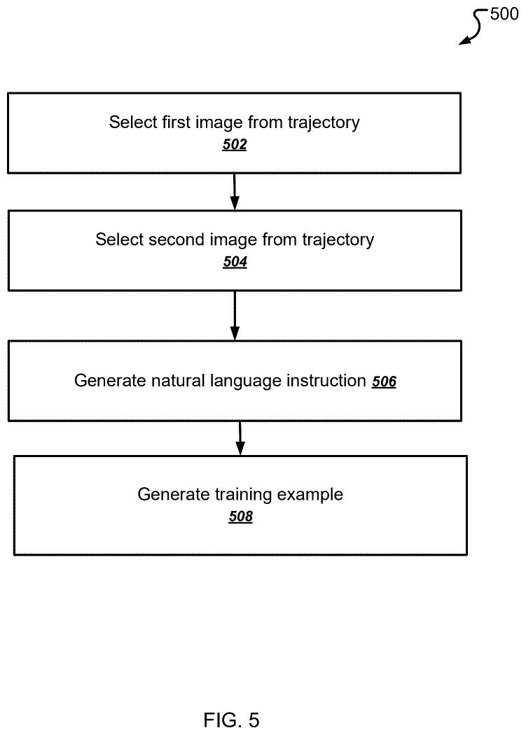

FIG. 5 is a flow diagram of an example process 500 for generating a training example from a given spatial trajectory. For convenience, the process 500 will be described as being performed by a system of one or more computers located in one or more locations. For example, a training system, e.g., the training system 100 depicted in FIG. 1, appropriately programmed in accordance with this specification, can perform the process 500.

The system selects a first image from the spatial trajectory (step 502).

The system selects a second image from the spatial trajectory (step 504). For example, the second image can be the adjacent image to the first image from the spatial trajectory. Alternatively, the second image can be another image sampled from the spatial trajectory.

The system generates a natural language editing instruction that specifies an edit that, when applied to the first image, generates the second image (step 506).

For example, the system can determine a relative change in field of view between the first and second image and then generate the natural language editing instruction based on the change in the field of view.

As one example, the system can generate the instruction by applying a template to the change in the field of view.

As another example, the system can generate the instruction by processing an input that describes the change in the field of view using a generative neural network. For example, the generative neural network can be a language model neural network, e.g., a multi-modal language model neural network.

The multi-modal language model neural network can generally be any appropriate language model neural network that can process tokens representing images and text to generate as output tokens representing text (and, optionally, images). As a particular example, the neural network can have any of a variety of Transformer-based neural network architectures, e.g., encoder-decoder Transformer architectures, decoder-only Transformer architectures, mixture-of-experts (MoE) Transformer architectures, other attention-based architectures, and so on. Examples of multi-modal language model neural networks with such Transformer-based neural network architectures include Gemini Team, et al., Gemini: a family of highly capable multimodal models. arXiv preprint arXiv:2312.11805 (2023); Comanici, Gheorghe, et al., Gemini 2.5: Pushing the frontier with advanced reasoning, multimodality, long context, and next generation agentic capabilities. arXiv preprint arXiv:2507.06261 (2025); and Gemma Team, et al., Gemma 3 technical report. arXiv preprint arXiv:2503.19786 (2025).

As yet another example, the system can generate the instruction using both a template and a generative neural network.

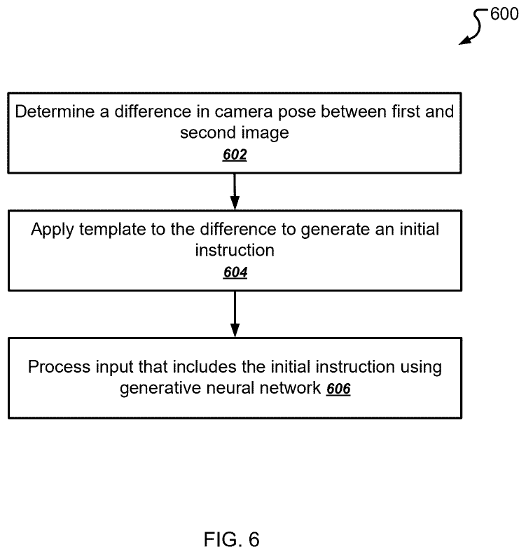

This example will be described in more detail below with reference to FIG. 6.

The system then generates the training example by setting (i) the first image to be the input image in the training example, (ii) the second image to be the target image in the training example, and (iii) the natural language editing instruction to be the natural language instruction in the training example (step 508).

FIG. 6 is a flow diagram of an example process 600 for generating a natural language instruction for a training example. For convenience, the process 600 will be described as being performed by a system of one or more computers located in one or more locations. For example, a training system, e.g., the training system 100 depicted in FIG. 1, appropriately programmed in accordance with this specification, can perform the process 600.

In particular, the example 600 describes an example in which the difference in the field of view between the first and second image is a difference in the camera pose between the first and second images. More generally, however, a similar process can be used to generate the instruction in cases where the difference in the field of view is a difference between zoom levels of the two images or where the difference is both a pose difference and a zoom level difference.

The system determines, from the respective camera pose data for the first and second images, a difference in camera pose between the first and second images (step 602).

For example, the difference in camera pose can be a measure of a relative camera rotation between the first and second images and a measure of a relative camera translation between the first and second images.

The relative camera rotation measures a change in the direction of the camera between the first and second images.

The relative camera translation measures a change in the position of the camera between the first and second images.

As a particular example, the respective camera pose for each image can represent the position of the camera using the x, y, and z coordinates of the camera in a specified coordinate system. The respective camera pose can represent the direction of the camera using one or more of the pitch of the camera, the yaw of the camera, and the role of the camera. Optionally, the respective camera pose can also include a magnification or zoom level for the camera.

The system can then determine the difference in camera pose by determining the relative camera translation as a vector of values that includes respective changes in each of the x, y, and z coordinates. Similarly, the system can determine the relative camera translation as a vector of values that includes respective changes in one or more of the pitch, the yaw, or the roll of the camera. Optionally, the difference can also include a change in the zoom level.

The system applies a template to the difference to generate an initial natural language editing instruction (step 604).

The template generally maps a camera pose difference to natural language text that describes the difference. For example, each template can include one or more natural language statements, each with one or more placeholders. For each placeholder in each natural language statement, the template specifies a rule for how to populate the placeholder with text derived from the difference in camera pose.

Thus, to apply the template, the system can select, e.g., randomly, one of the natural language statements in the template and, for each placeholder, apply the rule to the camera pose difference to populate the placeholder with text derived from the difference in camera pose. This yields the initial natural language editing instruction.

In some implementations, the system maintains multiple different templates and selects different ones of the templates for different training examples.

For example, the system can maintain one set of templates that are applicable to training examples where the camera pose difference is a change in rotation and another set of templates that are applicable to training examples where the camera pose difference is a change in translation.

As another example, each set of templates, i.e., the set for rotation and the set for translation, can include multiple different templates, with each mapping a camera pose difference to a description at a different level of generality. In this example, the system can randomly select which template to use to ensure that the resulting training example include instructions with different levels of generality, allowing the image generation system to, after training, effectively respond to multiple different types of prompts.

As one example, the template for the highest level of generality when the camera pose difference is a change in rotation can randomly select from a set of placeholder instructions that includes two or more of the following: “Take a peek <insert dominant rotation direction>,” “Give me a glipse of what's over <insert dominant rotation direction>,” or “Turn your head <insert dominant rotation direction>,” and then replace the < . . . > with the dominant rotation direction.

As another example, the template for the highest level of generality when the camera pose difference is a change in direction can randomly select from a set of placeholder instructions that includes two or more of the following: “Show me what's <insert dominant translation axis>,” “Go <insert dominant translation axis>,” or “Just a tad to the <insert dominant translation axis>,” and then replace the < . . . > with the domination translation axis.

The templates for lower levels of generality, i.e., more detail, can be similar but can include placeholders for more detailed descriptions of the changes in camera pose, e.g., descriptions that directly specify one or more of: the change along one of the axes of the 3D coordinate system, the change in yaw, the change in roll, or the change in tilt.

In some implementations, the system uses the initial natural language editing instruction as the final natural language instruction.

In some other implementations, the system uses a generative neural network to refine the initial natural language editing instruction.

In this example, the system processes, using the generative neural network, an input that includes (i) the initial natural language editing instruction and (ii) a prompt that instructs the generative neural network to improve the initial natural language editing instruction to generate the natural language editing instruction (step 606).

In some examples, the input does not include the first and second images. That is, the input is a text-only input that includes only the instruction to be refined and the prompt that specifies how to refine the instruction. Using the generative neural network to refine the initial instructions in this example results in final instructions that are more varied and more likely to closely match the inputs that will be received by the system at inference time, improving the quality of the training signal provided to the image generation system.

In other examples, however, the input to the generative neural network also includes the first image and the second image and the prompt instructs the generative neural network to describe visual differences between the first image and the second image. This yields a natural language instruction that requests both a change in camera pose and change in visual appearance that is caused by the change in camera pose. Thus, using the generative neural network in this example allows the image generation neural network to be trained to be able to more accurately reveal new portions of the scene that are described by input prompts after training.

In this specification, the term “configured” is used in relation to computing systems and environments, as well as computer program components. A computing system or environment is considered “configured” to perform specific operations or actions when it possesses the necessary software, firmware, hardware, or a combination thereof, enabling it to carry out those operations or actions during operation. For instance, configuring a system might involve installing a software library with specific algorithms, updating firmware with new instructions for handling data, or adding a hardware component for enhanced processing capabilities. Similarly, one or more computer programs are “configured” to perform particular operations or actions when they contain instructions that, upon execution by a computing device or hardware, cause the device to perform those intended operations or actions.

The embodiments and functional operations described in this specification can be implemented in various forms, including digital electronic circuitry, software, firmware, computer hardware (encompassing the disclosed structures and their structural equivalents), or any combination thereof. The subject matter can be realized as one or more computer programs, essentially modules of computer program instructions encoded on a tangible non-transitory storage medium for execution by or to control the operation of a computing device or hardware. The storage medium can be a storage device such as a hard drive or solid-state drive (SSD), a storage medium, a random or serial access memory device, or a combination of these. Additionally or alternatively, the program instructions can be encoded on a transmitted signal, such as a machine-generated electrical, optical, or electromagnetic signal, designed to carry information for transmission to a receiving device or system for execution by a computing device or hardware. Furthermore, implementations may leverage emerging technologies like quantum computing or neuromorphic computing for specific applications, and may be deployed in distributed or cloud-based environments where components reside on different machines or within a cloud infrastructure.

The term “computing device or hardware” refers to the physical components involved in data processing and encompasses all types of devices and machines used for this purpose. Examples include processors or processing units, computers, multiple processors or computers working together, graphics processing units (GPUs), tensor processing units (TPUs), and specialized processing hardware such as field-programmable gate arrays (FPGAs) or application-specific integrated circuits (ASICs). In addition to hardware, a computing device or hardware may also include code that creates an execution environment for computer programs. This code can take the form of processor firmware, a protocol stack, a database management system, an operating system, or a combination of these elements. Embodiments may particularly benefit from utilizing the parallel processing capabilities of GPUs, in a General-Purpose computing on Graphics Processing Units (GPGPU) context, where code specifically designed for GPU execution, often called kernels or shaders, is employed. Similarly, TPUs excel at running optimized tensor operations crucial for many machine learning algorithms. By leveraging these accelerators and their specialized programming models, the system can achieve significant speedups and efficiency gains for tasks involving artificial intelligence and machine learning, particularly in areas such as computer vision, natural language processing, and robotics.

A computer program, also referred to as software, an application, a module, a script, code, or simply a program, can be written in any programming language, including compiled or interpreted languages, and declarative or procedural languages. It can be deployed in various forms, such as a standalone program, a module, a component, a subroutine, or any other unit suitable for use within a computing environment. A program may or may not correspond to a single file in a file system and can be stored in various ways. This includes being embedded within a file containing other programs or data (e.g., scripts within a markup language document), residing in a dedicated file, or distributed across multiple coordinated files (e.g., files storing modules, subprograms, or code segments). A computer program can be executed on a single computer or across multiple computers, whether located at a single site or distributed across multiple sites and interconnected through a data communication network. The specific implementation of the computer programs may involve a combination of traditional programming languages and specialized languages or libraries designed for GPGPU programming or TPU utilization, depending on the chosen hardware platform and desired performance characteristics.

In this specification, the term “engine” broadly refers to a software-based system, subsystem, or process designed to perform one or more specific functions. An engine is typically implemented as one or more software modules or components installed on one or more computers, which can be located at a single site or distributed across multiple locations. In some instances, one or more dedicated computers may be used for a particular engine, while in other cases, multiple engines may operate concurrently on the same one or more computers. Examples of engine functions within the context of AI and machine learning could include data pre-processing and cleaning, feature engineering and extraction, model training and optimization, inference and prediction generation, and post-processing of results. The specific design and implementation of engines will depend on the overall architecture and the distribution of computational tasks across various hardware components, including CPUs, GPUs, TPUs, and other specialized processors.

The processes and logic flows described in this specification can be executed by one or more programmable computers running one or more computer programs to perform functions by operating on input data and generating output. Additionally, graphics processing units (GPUs) and tensor processing units (TPUs) can be utilized to enable concurrent execution of aspects of these processes and logic flows, significantly accelerating performance. This approach offers significant advantages for computationally intensive tasks often found in AI and machine learning applications, such as matrix multiplications, convolutions, and other operations that exhibit a high degree of parallelism. By leveraging the parallel processing capabilities of GPUs and TPUs, significant speedups and efficiency gains compared to relying solely on CPUs can be achieved. Alternatively or in combination with programmable computers and specialized processors, these processes and logic flows can also be implemented using specialized processing hardware, such as field-programmable gate arrays (FPGAs) or application-specific integrated circuits (ASICs), for even greater performance or energy efficiency in specific use cases.

Computers capable of executing a computer program can be based on general-purpose microprocessors, special-purpose microprocessors, or a combination of both. They can also utilize any other type of central processing unit (CPU). Additionally, graphics processing units (GPUs), tensor processing units (TPUs), and other machine learning accelerators can be employed to enhance performance, particularly for tasks involving artificial intelligence and machine learning. These accelerators often work in conjunction with CPUs, handling specialized computations while the CPU manages overall system operations and other tasks. Typically, a CPU receives instructions and data from read-only memory (ROM), random access memory (RAM), or both. The elements of a computer include a CPU for executing instructions and one or more memory devices for storing instructions and data. The specific configuration of processing units and memory will depend on factors like the complexity of the AI model, the volume of data being processed, and the desired performance and latency requirements. Embodiments can be implemented on a wide range of computing platforms, from small embedded devices with limited resources to large-scale data center systems with high-performance computing capabilities. The system may include storage devices like hard drives, SSDs, or flash memory for persistent data storage.

Computer-readable media suitable for storing computer program instructions and data encompass all forms of non-volatile memory, media, and memory devices. Examples include semiconductor memory devices such as read-only memory (ROM), solid-state drives (SSDs), and flash memory devices; hard disk drives (HDDs); optical media; and optical discs such as CDs, DVDs, and Blu-ray discs. The specific type of computer-readable media used will depend on factors such as the size of the data, access speed requirements, cost considerations, and the desired level of portability or permanence.

To facilitate user interaction, embodiments of the subject matter described in this specification can be implemented on a computing device equipped with a display device, such as a liquid crystal display (LCD) or an organic light-emitting diode (OLED) display, for presenting information to the user. Input can be provided by the user through various means, including a keyboard), touchscreens, voice commands, gesture recognition, or other input modalities depending on the specific device and application. Additional input methods can include acoustic, speech, or tactile input, while feedback to the user can take the form of visual, auditory, or tactile feedback. Furthermore, computers can interact with users by exchanging documents with a user's device or application. This can involve sending web content or data in response to requests or sending and receiving text messages or other forms of messages through mobile devices or messaging platforms. The selection of input and output modalities will depend on the specific application and the desired form of user interaction.

Machine learning models can be implemented and deployed using machine learning frameworks, such as TensorFlow or JAX. These frameworks offer comprehensive tools and libraries that facilitate the development, training, and deployment of machine learning models.

Embodiments of the subject matter described in this specification can be implemented within a computing system comprising one or more components, depending on the specific application and requirements. These may include a back-end component, such as a back-end server or cloud-based infrastructure; an optional middleware component, such as a middleware server or application programming interface (API), to facilitate communication and data exchange; and a front-end component, such as a client device with a user interface, a web browser, or an app, through which a user can interact with the implemented subject matter. For instance, the described functionality could be implemented solely on a client device (e.g., for on-device machine learning) or deployed as a combination of front-end and back-end components for more complex applications. These components, when present, can be interconnected using any form or medium of digital data communication, such as a communication network like a local area network (LAN) or a wide area network (WAN) including the Internet. The specific system architecture and choice of components will depend on factors such as the scale of the application, the need for real-time processing, data security requirements, and the desired user experience.

The computing system can include clients and servers that may be geographically separated and interact through a communication network. The specific type of network, such as a local area network (LAN), a wide area network (WAN), or the Internet, will depend on the reach and scale of the application. The client-server relationship is established through computer programs running on the respective computers and designed to communicate with each other using appropriate protocols. These protocols may include HTTP, TCP/IP, or other specialized protocols depending on the nature of the data being exchanged and the security requirements of the system. In certain embodiments, a server transmits data or instructions to a user's device, such as a computer, smartphone, or tablet, acting as a client. The client device can then process the received information, display results to the user, and potentially send data or feedback back to the server for further processing or storage. This allows for dynamic interactions between the user and the system, enabling a wide range of applications and functionalities.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method performed by one or more computers and for training an image generation system:
obtaining an initial data set;
generating, from the initial data set, a plurality of spatial trajectories of images;
generating, using the spatial trajectories of images, a plurality of training examples, each training example comprising (i) an input image, (ii) a natural language instruction, and (iii) a target image that represents an image generated by applying an edit specified by the natural language instruction to the input image, wherein the natural language instruction specifies a change in camera pose to be applied to a camera pose of a camera corresponding to the source image; and
providing the plurality of training examples for training the image generation system.

2. The method of claim 1, further comprising:
training the image generation system on the plurality of training examples.

3. The method of claim 1, wherein generating, using the spatial trajectories of images, a plurality of training examples, comprises, for each training example:
selecting a spatial trajectory from the plurality of spatial trajectories;
selecting a first image from the selected spatial trajectory;
selecting a second image from the selected spatial trajectory;
generating a natural language editing instruction that specifies an edit that, when applied to the first image, generates the second image; and
setting (i) the first image to be the input image in the training example, (ii) the second image to be the target image in the training example, and (iii) the natural language editing instruction to be the natural language instruction in the training example.

4. The method of claim 3, wherein each spatial trajectory comprises, for each image in the spatial trajectory, respective camera pose data specifying a camera pose corresponding to the image.

5. The method of claim 4, wherein generating the natural language editing instruction comprises:
determining, from the respective camera pose data for the first and second images, a difference in camera pose between the first and second images; and
applying a template to the difference to generate an initial natural language editing instruction.

6. The method of claim 5, wherein generating the natural language editing instruction comprises:
setting the initial natural language editing instruction as the natural language editing instruction.

7. The method of claim 6, wherein generating the natural language editing instruction comprises:
processing, using a generative neural network, an input comprising (i) the initial natural language editing instruction and (ii) a prompt that instructs the generative neural network to improve the initial natural language editing instruction to generate the natural language editing instruction.

8. The method of claim 7, wherein the input to the generative neural network further comprises the first image and the second image and the prompt instructs the generative neural network to describe visual differences between the first image and the second image.

9. The method of claim 5, wherein the difference comprises a measure of a relative camera rotation between the first and second images and a measure of a relative camera translation between the first and second images.

10. The method of claim 1, wherein the initial data set comprises a set of three-dimensional (3D) assets that each define a 3D representation of a corresponding 3D scene.

11. The method of claim 10, wherein generating, from the initial data set, a plurality of spatial trajectories of images comprises, for each of the set of 3D assets, generating a respective spatial trajectory from the 3D asset by, for each of a plurality of camera poses, rendering, using the 3D asset, a respective image of the corresponding 3D scene taken from the camera pose.

12. The method of claim 11, wherein the plurality of camera poses comprise points on a N-degree of freedom grid of camera pose locations within the corresponding 3D scene.

13. The method of claim 1, wherein the initial data set comprises a set of videos that each depict a respective scene and that are each captured with dynamic camera motion.

14. The method of claim 13, wherein generating, from the initial data set, a plurality of spatial trajectories of images comprises, for each of the videos, generating a respective spatial trajectory from the video by sampling video frames the video.

15. The method of claim 2, further comprising, after the training:
receiving a new image and a new instruction that specifies a new edit to the new image; and
processing the new image and the new instruction using the image generation system to generate a new output image in which the new edit has been applied to the new image.

16. The method of claim 1, wherein the natural language instruction specifies visual differences between the source and target images caused by the change in camera pose.

17. One or more non-transitory computer storage media storing instructions that when executed by one or more computers cause the one or more computers to perform operations for training an image generation system, the operations comprising:
obtaining an initial data set;
generating, from the initial data set, a plurality of spatial trajectories of images;
generating, using the spatial trajectories of images, a plurality of training examples, each training example comprising (i) an input image, (ii) a natural language instruction, and (iii) a target image generated by applying an edit specified by the natural language instruction to the input image, wherein the natural language instruction specifies a change in camera pose to be applied to a camera pose of a camera corresponding to the source image; and
providing the plurality of training examples for training the image generation system.

18. A system comprising:
one or more computers; and
one or more storage devices communicatively coupled to the one or more computers, wherein the one or more storage devices store instructions that, when executed by the one or more computers, cause the one or more computers to perform operations for training an image generation system, the operations comprising:
obtaining an initial data set;
generating, from the initial data set, a plurality of spatial trajectories of images;
generating, using the spatial trajectories of images, a plurality of training examples, each training example comprising (i) an input image, (ii) a natural language instruction, and (iii) a target image generated by applying an edit specified by the natural language instruction to the input image, wherein the natural language instruction specifies a change in camera pose to be applied to a camera pose of a camera corresponding to the source image; and
providing the plurality of training examples for training the image generation system.

19. The system of claim 18, the operations further comprising:
training the image generation system on the plurality of training examples.

20. The system of claim 18, wherein generating, using the spatial trajectories of images, a plurality of training examples, comprises, for each training example:
selecting a spatial trajectory from the plurality of spatial trajectories;
selecting a first image from the selected spatial trajectory;
selecting a second image from the selected spatial trajectory;
generating a natural language editing instruction that specifies an edit that, when applied to the first image, generates the second image; and
setting (i) the first image to be the input image in the training example, (ii) the second image to be the target image in the training example, and (iii) the natural language editing instruction to be the natural language instruction in the training example.
